(19) United States
(12) Patent Application Publication
(10) Pub. No.: US 2024/0288015 A1
(43) Pub. Date: Aug. 29, 2024

(54) CLICK-LOCK ASSEMBLIES

(71) Applicants: Alan Taylor, Myakka City, FL (US); Jerry Jordan, Bradenton, FL (US); Stephan Garcia, Bradenton, FL (US)

(72) Inventors: Alan Taylor, Myakka City, FL (US); Jerry Jordan, Bradenton, FL (US); Stephan Garcia, Bradenton, FL (US)

(21) Appl. No.: 18/587,938

(22) Filed: Feb. 26, 2024

Related U.S. Application Data
(60) Provisional application No. 63/448,240, filed on Feb. 24, 2023.

(51) Int. Cl. F16B 1/00

(52) U.S. Cl. CPC F16B 1/00

(57) ABSTRACT

Various click-lock assemblies that engage a component and that are releasable by pressing one or more release latches are described.

### RELATED APPLICATIONS

This application claims the benefit of U.S. Application No. 63/448,240, entitled “Click-lock Assembly,” and filed on Feb. 24, 2023, which is incorporated herein by reference in its entirety.

### FIELD

Some implementations relate generally to latching devices and assemblies, and, more particularly, to click-lock assemblies that engage a component and that are releasable by pressing one or more release latches.

### BACKGROUND

A need may exist for a latch or locking assembly that provides both a secure connection between two or more components and which is also easily releasable using finger pressure to release one or more latches so as to make disassembly or parts replacement relatively easy compared to conventional devices or mechanisms that may require tools to attach and release.

Embodiments were conceived in light of the above-mentioned problems and limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a click-lock assembly comprising a plurality of locking slides each having a button, a planar member, and a recess at a distal end, wherein the plurality of locking slides are configured to move from a first position to a second position when force is applied to a respective button of each slide, wherein the recesses of the plurality of locking slides forms a central aperture when the plurality of locking slides are in the first position, and wherein, in the first position, each of the plurality of locking slides is configured to engage an element within a central aperture, and wherein in the second position, the central aperture is extenuated so as to release the element within the central aperture. The click-lock assembly can also include a frame configured to retain the plurality of locking slides so as to permit the locking slide to move from the first position to the second position, and a plurality of springs, each spring corresponding to a respective one of the plurality of locking slides.

In some implementations, the plurality of locking slides includes a first locking slide and a second locking slide, wherein the plurality of springs includes a first spring and a second spring, wherein the first locking slide and the second locking slide are installed in the frame such that a first force of the first spring urges the first locking slide toward a first position of the first locking slide and a second force of the spring urges the second locking slide toward a first position of the second locking slide. In some implementations, the first force acts in a direction opposite to the second force, and wherein the first force and the second force both act in a radially outward direction from the central aperture of the click-lock mechanism to cause the central aperture to be reduced to engage the element within the central aperture.

In some implementations, to release the click-lock assembly, a first release force urges the first locking slide to a first locking slide second position and a second release force urges the second locking slide to a second locking slide second position. In some implementations, the first release force acts in a direction opposite to the second release force, and wherein the first release force and the second release force are in a direction radially inward toward the central aperture so as to extenuate the central aperture to permit the click-lock assembly to be released from the element within the central aperture.

In some implementations, each distal end of the plurality of locking slides includes an angle in an axial direction relative to the central aperture such that the angle urges the plurality of locking slides from the first position to the second position when the element is inserted into the central aperture from an insertion direction aligned axially with the central aperture, wherein once the element is inserted a given distance into the central aperture, the plurality of locking slides each return to the first position and prevent the element from being removed in a removal direction aligned axially with the central aperture, where the removal direction is opposite to the insertion direction.

In some implementations, the frame includes a first fixture plate and a second fixture plate, wherein the first fixture plate and the second fixture plate are joined together with one or more fasteners, and wherein the locking slides and springs are secure between the first fixture plate and the second fixture plate. In some implementations, the central aperture is formed so as to engage a profile of the element along a first plane, and the locking slides are formed so as to engage an undercut on the element.

In some implementations, the element includes a mounting rail. In some implementations, the element includes one of a slot, a striker, a tang, or a post.

In some implementations, the central aperture can include one or more surface configured to index the element in one or more positions. In some implementations, the click-lock assembly further comprising a plurality of spring loaded safety buttons that are configured to lock the plurality of locking slides into the first position to prevent accidental release, wherein to move the plurality of locking slides form the first position to the second position, a respective spring loaded safety lock must be disengaged to permit the corresponding locking slide to move from the first position to the second position.

Some implementations can include a click-lock assembly having a locking slide having a button, a planar member, and a recess at a distal end, wherein the locking slide is configured to move from a first position to a second position when force is applied to the button, wherein the recess of the locking slide forms a central aperture when the locking slide is in the first position, and wherein, in the first position, the locking slide is configured to engage an element within a central aperture, and wherein in the second position, the central aperture is extenuated so as to release the element within the central aperture. The click-lock assembly can also include a frame configured to retain the locking slide so as to permit the locking slide to move from the first position to the second position, and a spring corresponding to the locking slide.

In some implementations, the locking slide is installed in the frame such that a force of the spring urges the locking slide toward a first position of the locking slide. In some implementations, the force of the spring acts in a radially outward direction from the central aperture of the click-lock assembly to cause the central aperture to be reduced to engage the element within the central aperture.

In some implementations, to release the click-lock assembly, a release force urges the locking slide to the second position. In some implementations, the release force is in a direction radially inward toward the central aperture so as to extenuate the central aperture to permit the click-lock assembly to be released from the element within the central aperture. In some implementations, the distal end of the locking slide includes an angle in an axial direction relative to the central aperture such that the angle urges the locking slide from the first position to the second position when the element is inserted into the central aperture from an insertion direction aligned axially with the central aperture, wherein once the element is inserted a given distance into the central aperture, the locking slide returns to the first position and prevents the element from being removed in a removal direction aligned axially with the central aperture, where the removal direction is opposite to the insertion direction. In some implementations, the central aperture is formed so as to engage a profile of the element along a first plane, and the locking slide is formed so as to engage an undercut on the element.

In some implementations, the central aperture can include one or more surfaces configured to index the element in one or more positions.

### BRIEF DESCRIPTION OF THE DRAWINGS

FIGS. 1-3 are diagrams showing an example first embodiment of a click-lock assembly configured for rotor blade attachment in accordance with some implementations.

FIGS. 4-11 are diagrams showing an example second embodiment of a click-lock assembly configured for propeller hub/spinner attachment in accordance with some implementations.

FIGS. 12-15 are diagrams showing an example third embodiment of a click-lock assembly configured for a motor shroud or other shroud in accordance with some implementations.

FIGS. 16-19 are diagrams showing an example fourth embodiment of a click-lock assembly configured for attachment to an end of a pole in accordance with some implementations.

FIGS. 20-25 are diagrams showing an example fifth embodiment of a click-lock assembly configured for attachment of an accessory or implement to a rail system in accordance with some implementations.

FIGS. 26-27 are diagrams showing an example sixth embodiment of a click-lock assembly configured for attachment of a fishing rod holder to a rail system in accordance with some implementations.

### DETAILED DESCRIPTION

In general, some implementations can include a click-lock mechanisms configured for a variety of uses including, but not limited to: securing a folding propeller hub/spinner to a drive shaft, securing a propeller hub/spinner to a drive shaft, mounting accessories or implements on a weapon system (e.g., via a Picatinny rail or the like), mounting implements or holders (e.g., a fishing rod holder) on a vessel or vehicle, and/or securing tools to a tool belt. The propeller implementations can be for aerial vehicle propellers or watercraft propellers.

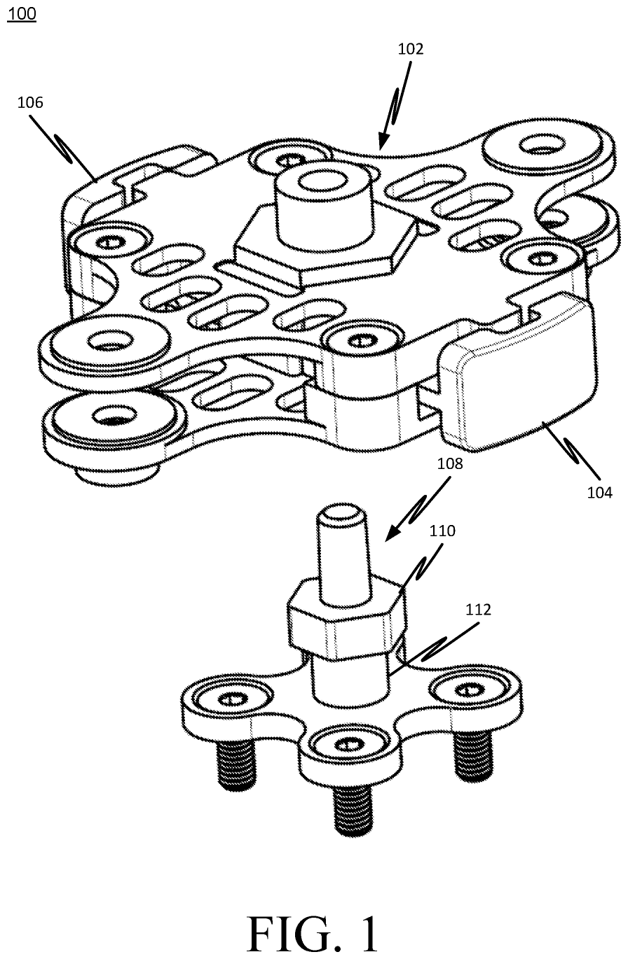

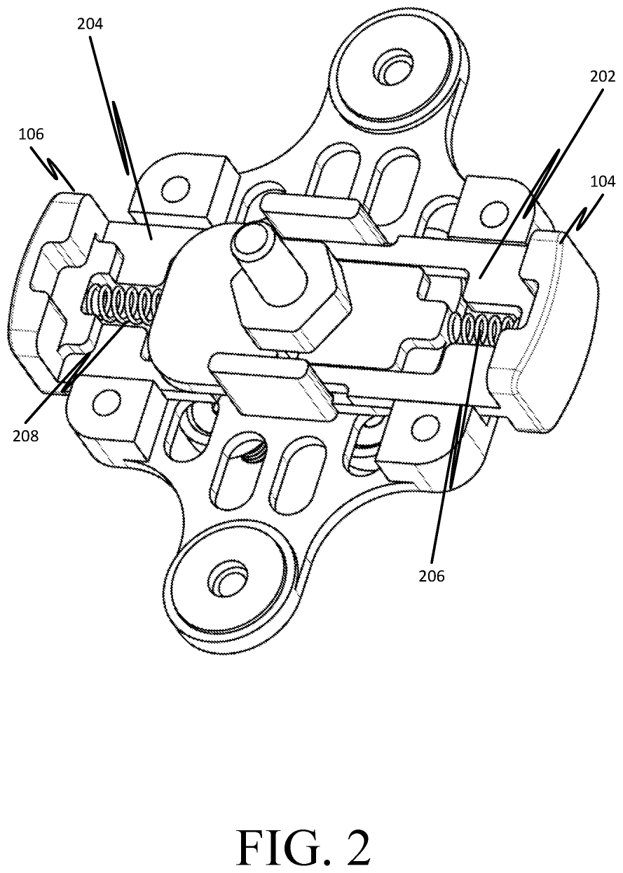

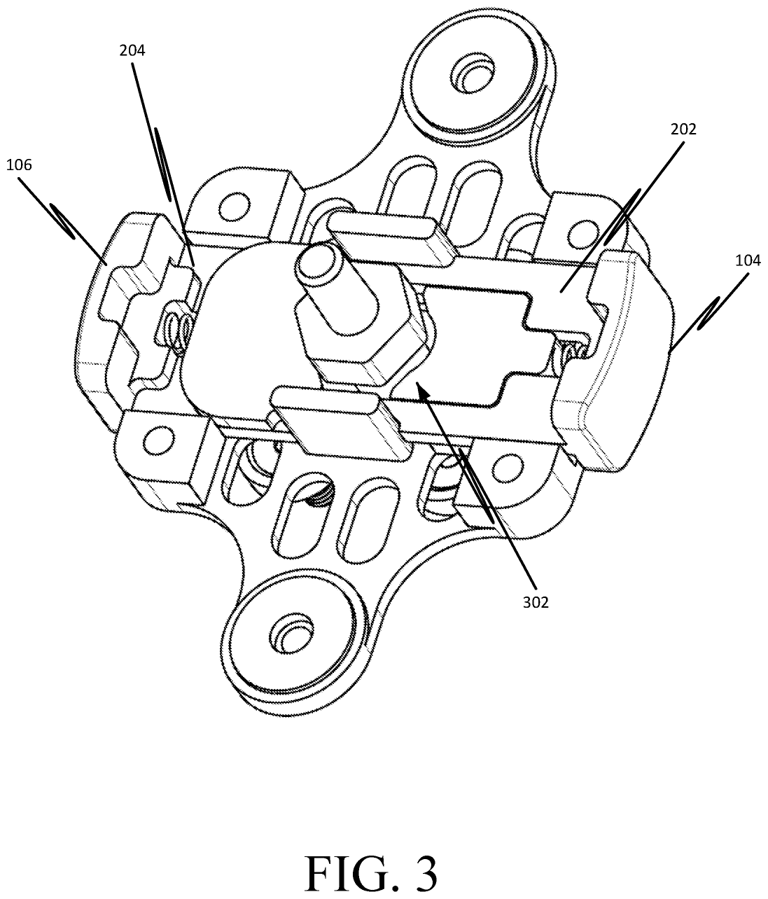

FIGS. 1-3 are diagrams showing an example first embodiment of a click-lock assembly 100 configured for rotor blade attachment in accordance with some implementations. The click-lock assembly 100 includes a frame 102, a first button 104, and a second button 106. A post 108 is configured to insert into a central aperture (see, FIGS. 2-3) of the click-lock assembly 100. The post 108 can include a multi-sided member 110 design to index into one or more positions when inserted into the click-lock assembly 100. The post also includes an undercut 112 where locking slides engage the post 108 to secure it in place until released.

FIG. 2 shows the click-lock assembly 100 in a locked position where locking slides 202 and 204 are urged into a first position (e.g., locked position) by springs 206 and 208, respectively.

FIG. 3 shows the click-lock assembly 100 in a released position wherein the locking slides 202 and 204 have been urged against the spring by force on the buttons 104/106 to cause the aperture formed by the distal ends of the locking slides to extenuate 302 to permit the post 108 to be removed from the click-lock assembly.

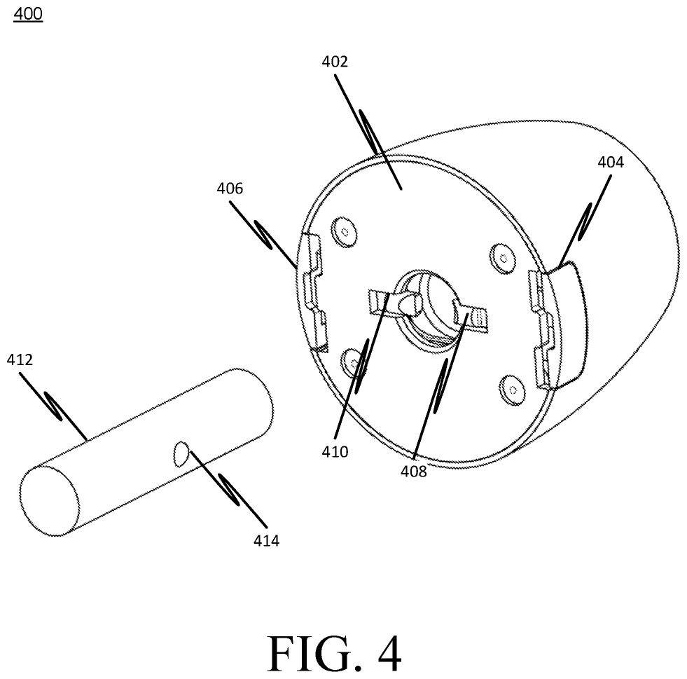

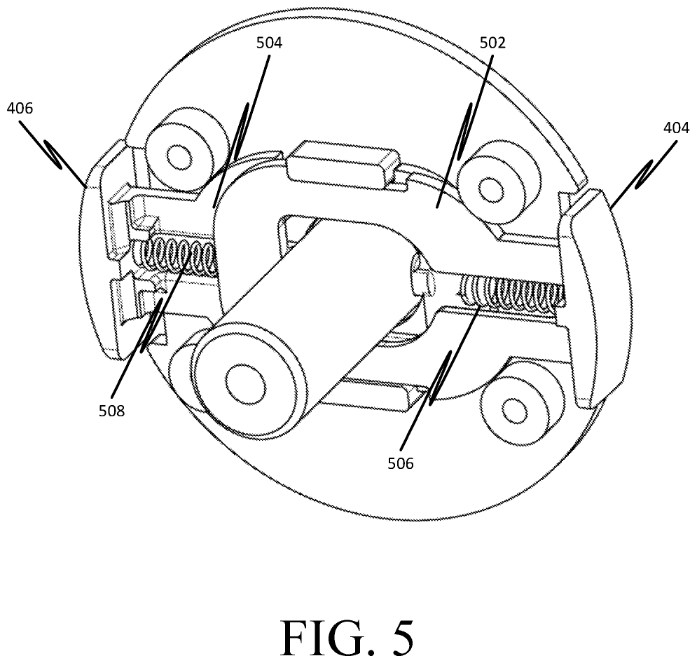

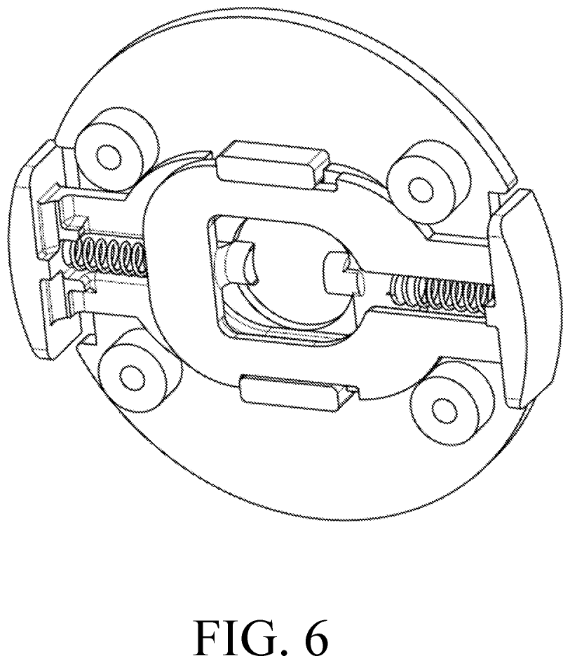

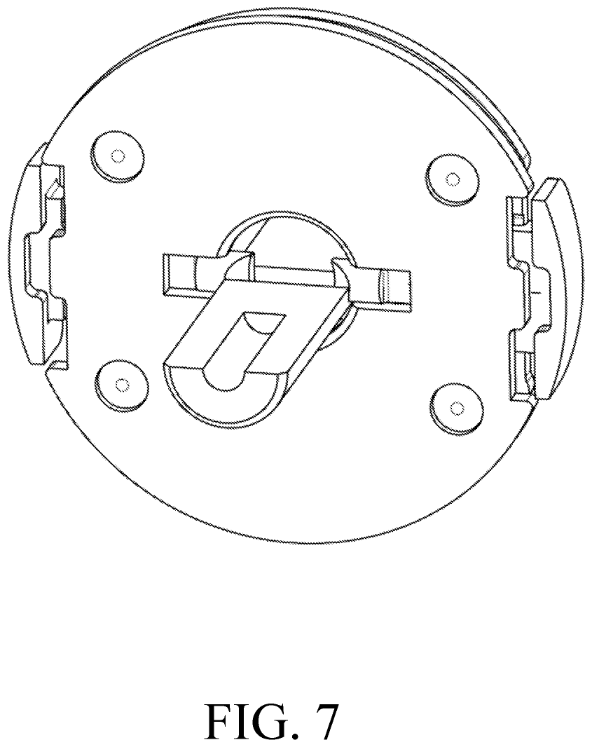

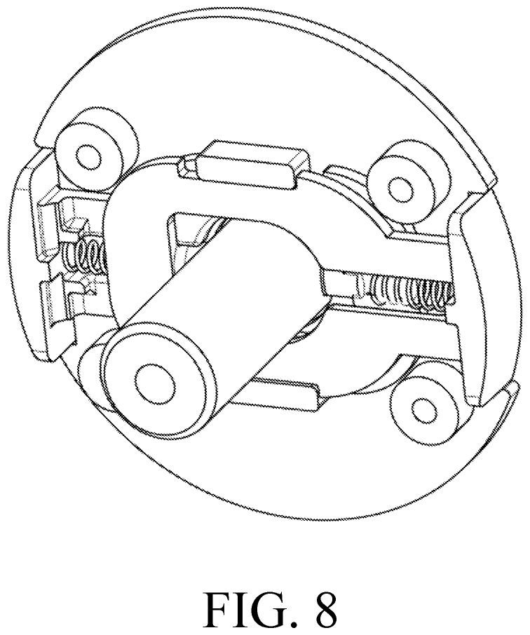

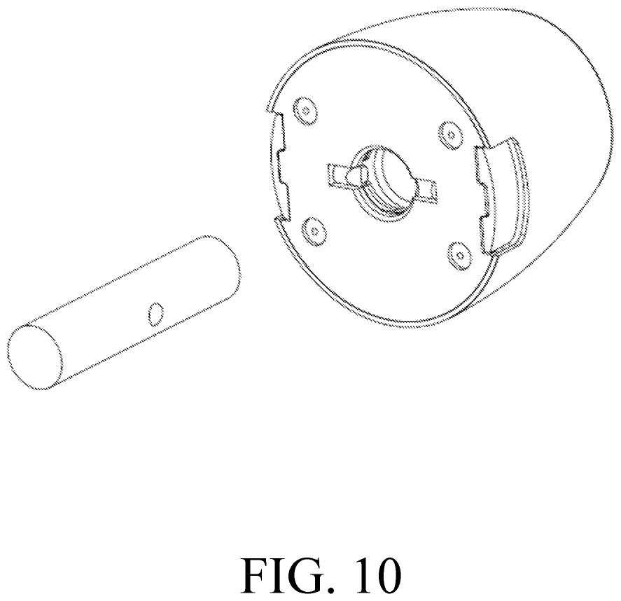

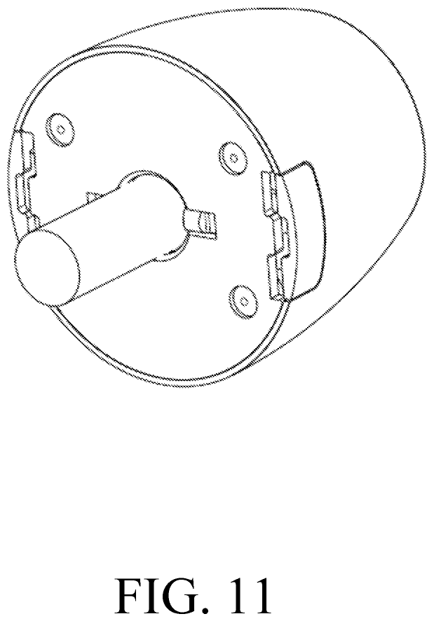

FIGS. 4-11 are diagrams showing an example second embodiment of a click-lock assembly 400 configured for propeller hub/spinner attachment in accordance with some implementations. The click-lock assembly 400 includes a frame 402, a first button 404, a second button 406, a first locking slide angled distal end 408, and a second locking slide angled distal end 410. A shaft 412 having indents 414, when inserted into the central aperture of the click-lock assembly 440 will be locked into place (see, e.g., FIG. 5).

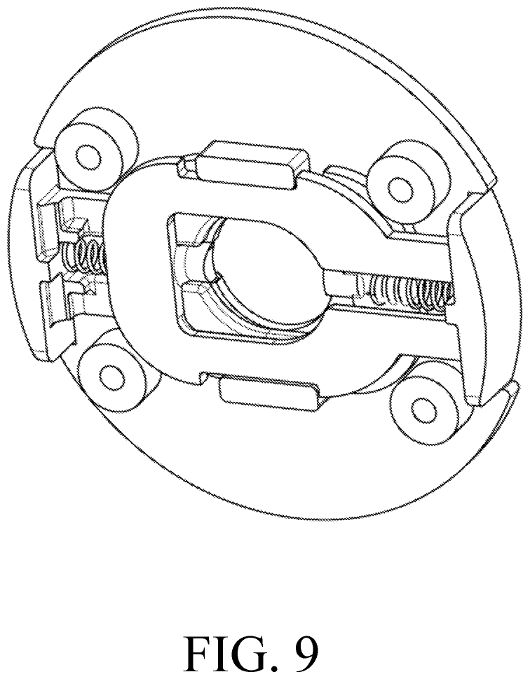

As shown in FIG. 5, locking slides 502 and 504 are urged into a first (locked) position by springs 506 and 508 respectively. When the buttons are pressed, the force causes the distal ends of the locking slides to retract or move to a second (unlocked) position as shown in FIG. 9.

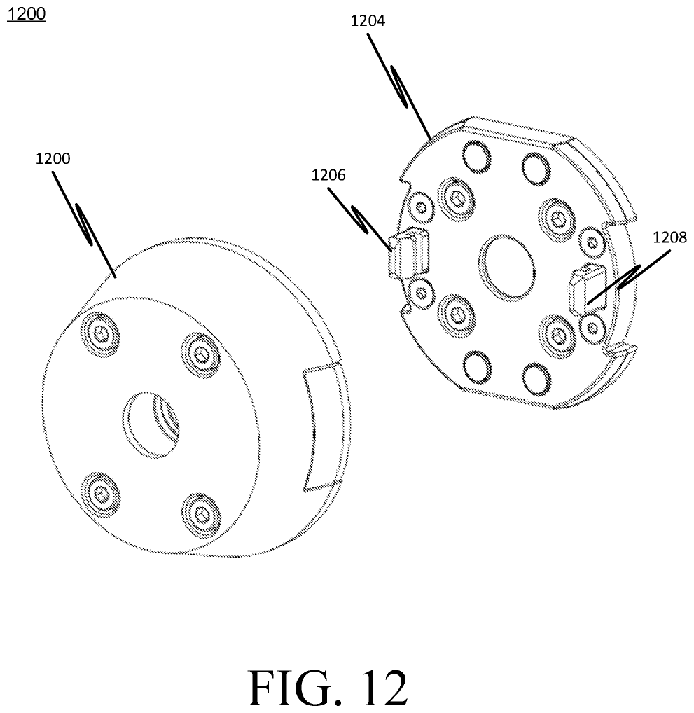

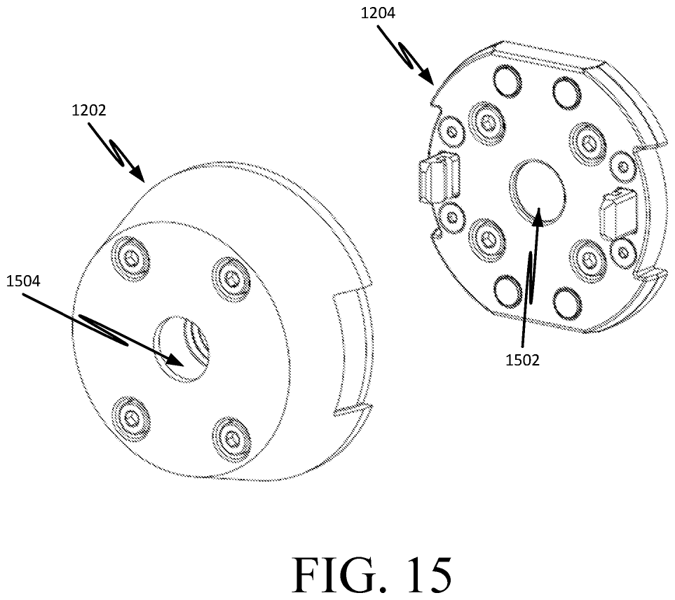

FIGS. 12-15 are diagrams showing an example third embodiment of a click-lock assembly 1200 configured for a motor shroud or other shroud in accordance with some implementations. The click-lock assembly 1200 includes a member 1204 with two posts 1206 and 1208, and a member 1202 with locking slides.

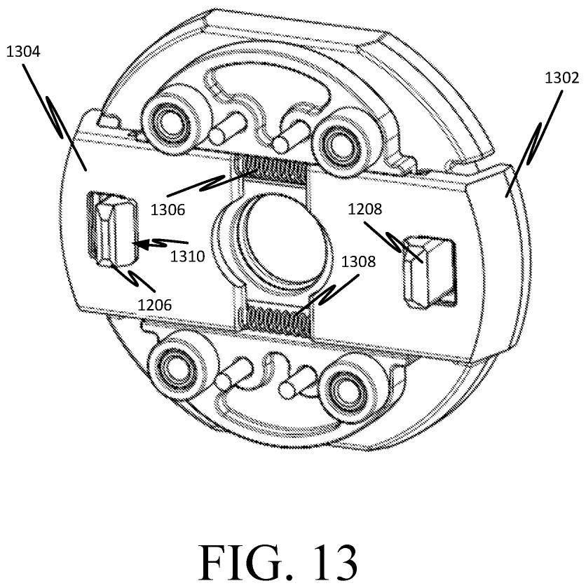

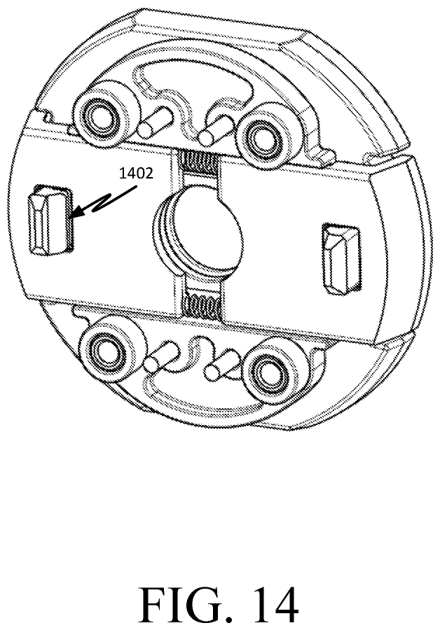

As shown in FIG. 13, a first locking slide 1302 and a second locking slide 1304 are in a first (or locked) position 1310 urged into place by springs 1306 and 1308. FIG. 14 shows the locking slides moved inward to a second (or unlocked) position 1402.

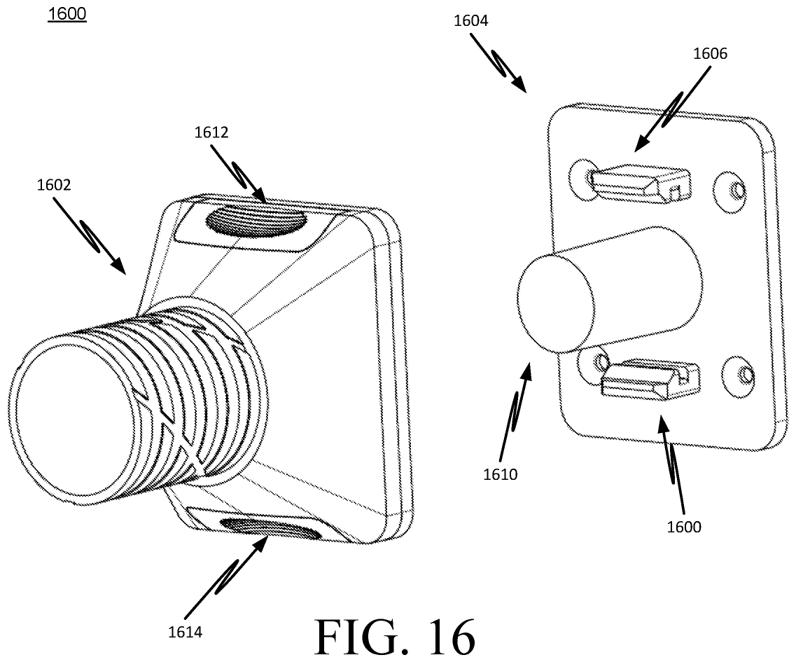

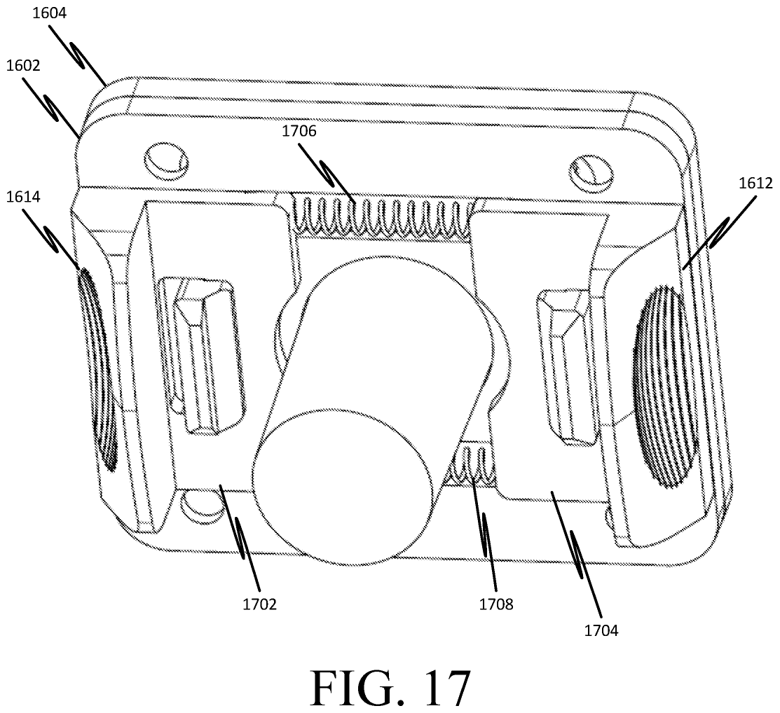

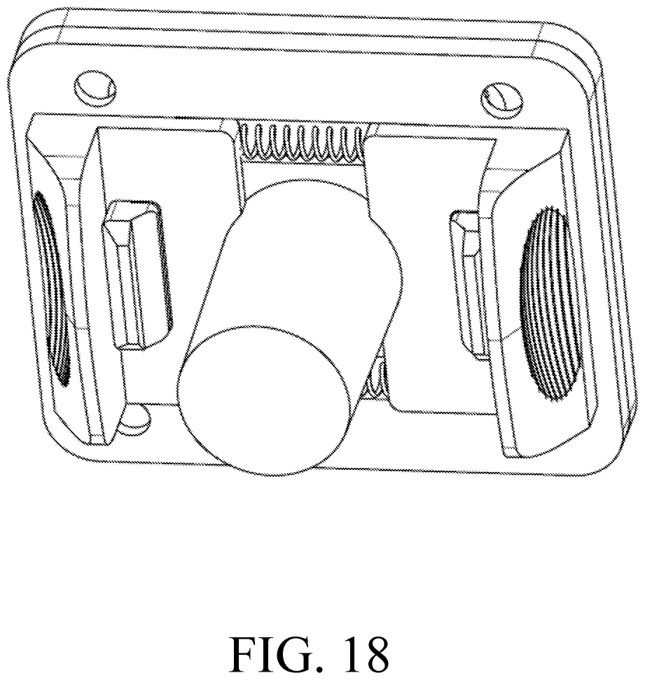

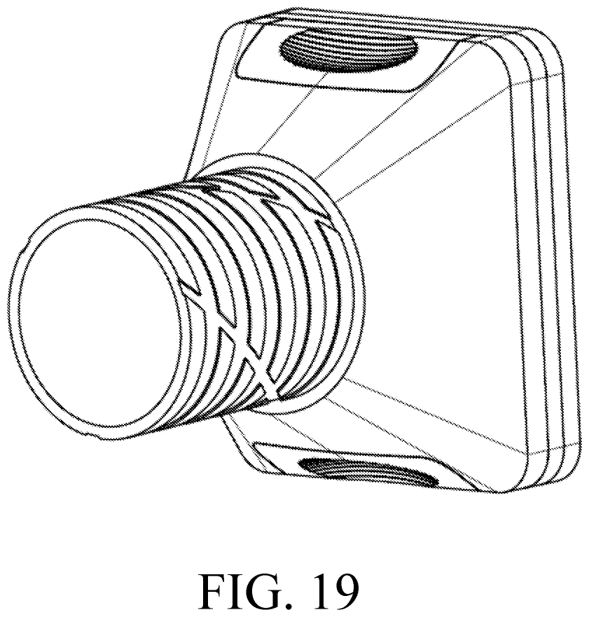

FIGS. 16-19 are diagrams showing an example fourth embodiment of a click-lock assembly 1600 configured for attachment to an end of a pole in accordance with some implementations. The click-lock assembly includes a cover 1602 having the locking slides and buttons 1612/1614 configured to connect to a member 1604 having posts 1606/1608 and central post 1610. FIG. 17 shows locking slides 1702 and 1704 in a first (or locked) position urged by force from springs 1704/1706.

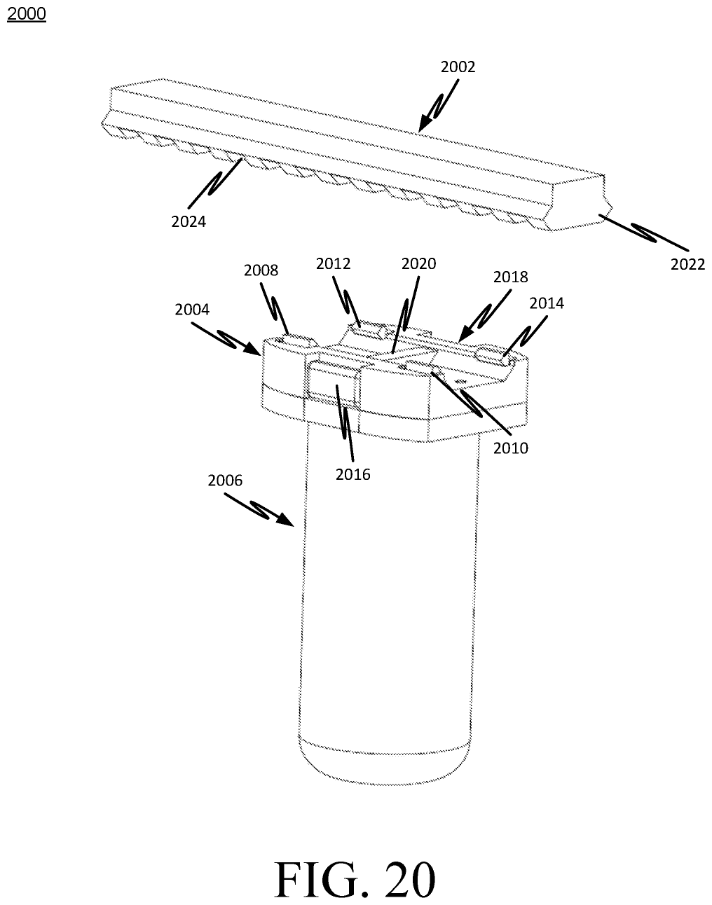

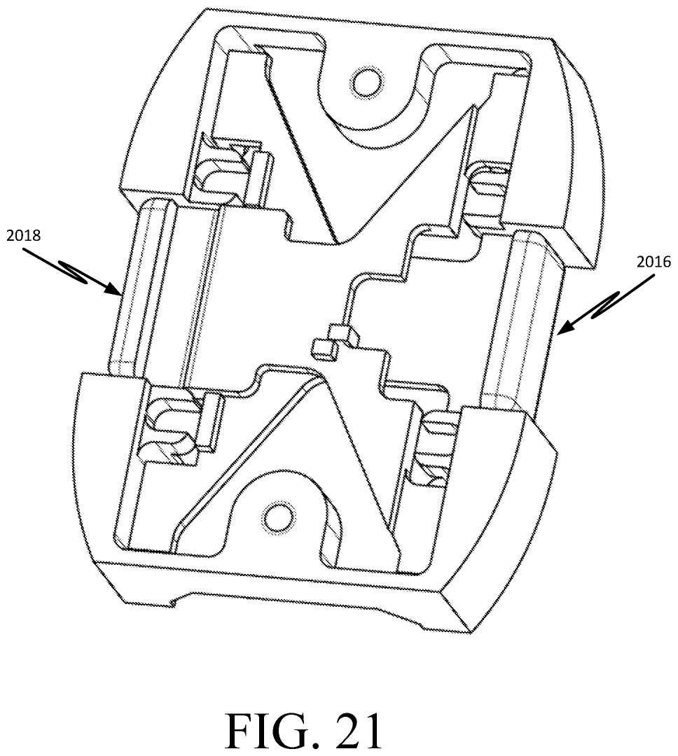

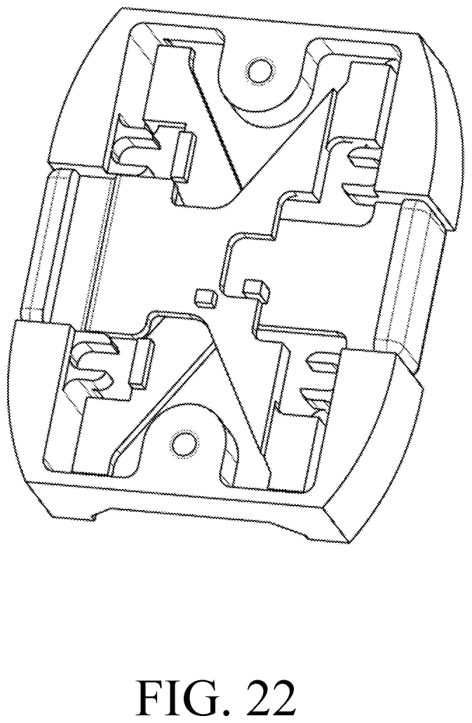

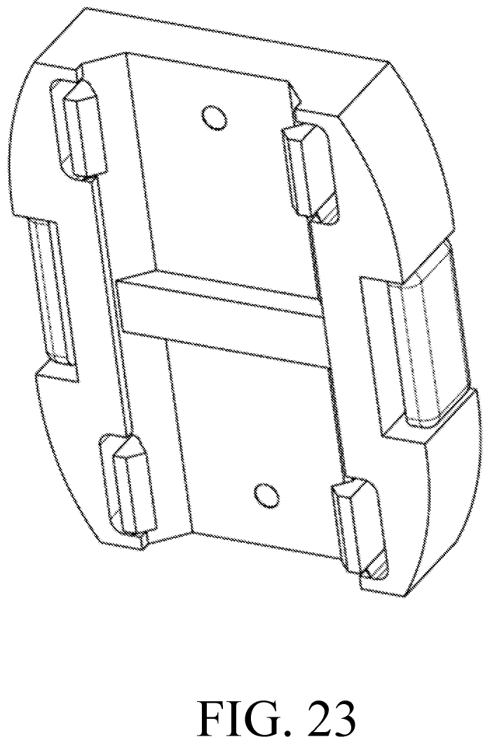

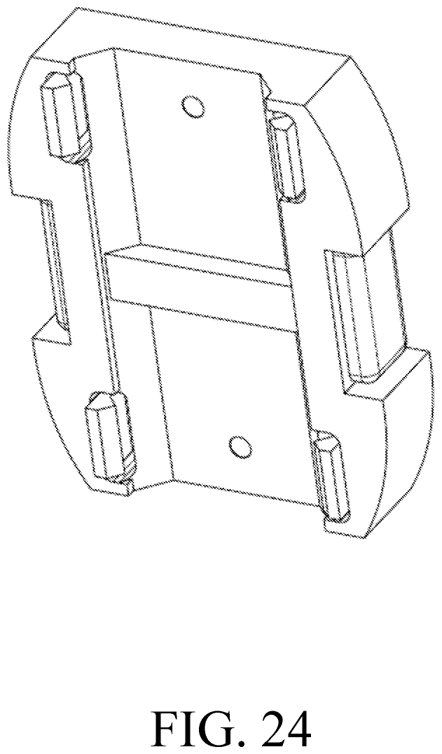

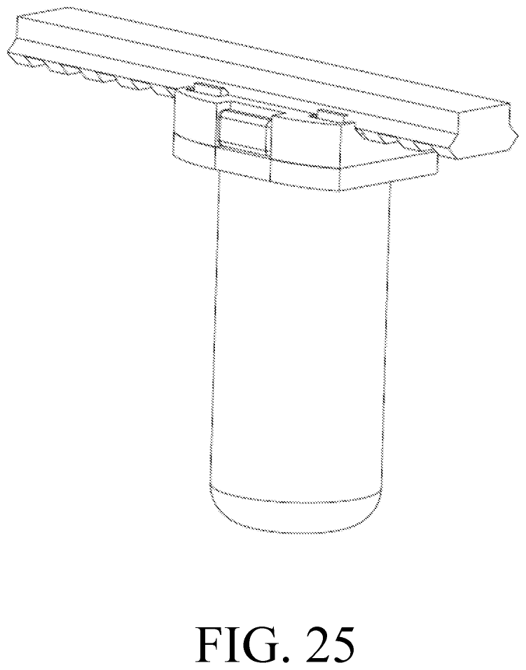

FIGS. 20-25 are diagrams showing an example fifth embodiment of a click-lock assembly 2000 configured for attachment of an accessory or implement to a rail system in accordance with some implementations. A rail 2002 (e.g., Picatinny rail or the like) includes a profile geometry 2022 and a plurality of spaced grooves 2024.

An accessory 2006 (e.g., a hand grip for a weapon system) can be mounted to the rail using a click-lock assembly 2004 having two buttons 2016/2018 (not visible), a plurality of distal ends (2008, 2010, 2012, and 2014) attach to locking slides that are moveable to releasably engage the rail geometry 2022 and a central tab 2020 configured to fit into a slot 2024.

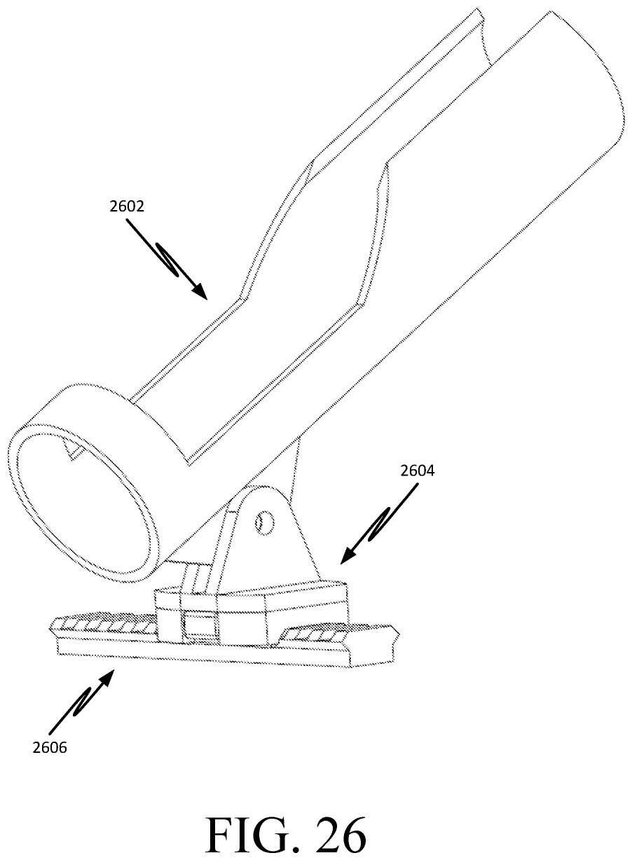

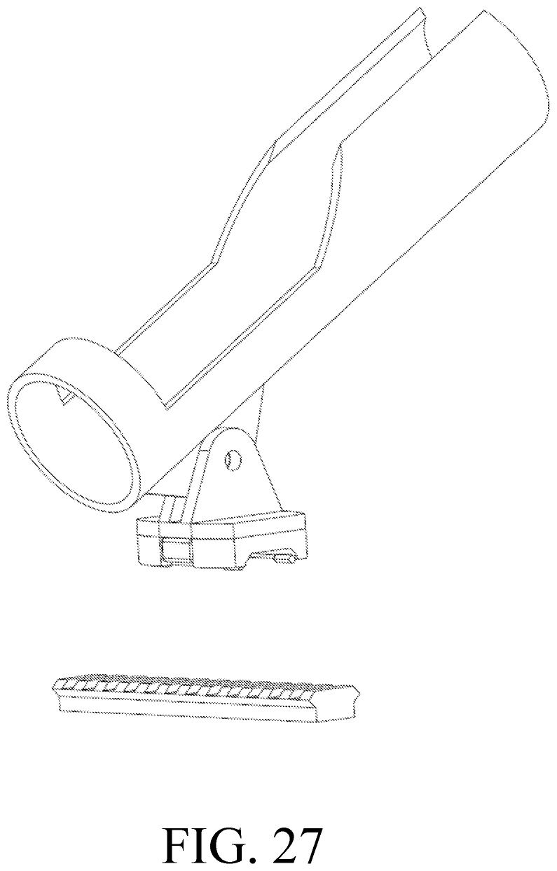

FIGS. 26-27 are diagrams showing an example sixth embodiment of a click-lock assembly configured for attachment of a fishing rod holder to a rail system in accordance with some implementations. The implementation of FIGS. 26-27 is similar to that shown in FIGS. 20-25 with a difference being that a fishing rod holder is being attached to the rail instead of a weapon system hand grip.

It will be appreciated that the click-lock system can be configured to releasably secure two items to each other. Further, an implementation can have two locking slides, one locking slide, or a different number of locking slides. One locking slide can be used for implementations where high security may not be critical (e.g., fishing rod holder).

A single locking slide implementation may not be suitable for applications where the click-lock mechanism may be in motion such as rotational motion (e.g., FIGS. 1-3). To address the asymmetric weight of a single button implementation, a counterweight may be added at an appropriate location to counterbalance the click-lock mechanism. In some instances, an imbalance may be desired, such as where a click-lock assembly is used to attach a striking tool head to a handle and the heavier side of the click-lock assembly may be position toward the striking side of the tool.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. A click-lock assembly comprising:
a plurality of locking slides each having a button, a planar member, and a recess at a distal end, wherein the plurality of locking slides are configured to move from a first position to a second position when force is applied to a respective button of each slide, wherein the recesses of the plurality of locking slides forms a central aperture when the plurality of locking slides are in the first position, and wherein, in the first position, each of the plurality of locking slides is configured to engage an element within a central aperture, and wherein in the second position, the central aperture is extenuated so as to release the element within the central aperture;
a frame configured to retain the plurality of locking slides so as to permit the locking slide to move from the first position to the second position; and
a plurality of springs, each spring corresponding to a respective one of the plurality of locking slides.

2. The click-lock assembly of claim 1, wherein the plurality of locking slides includes a first locking slide and a second locking slide, wherein the plurality of springs includes a first spring and a second spring, wherein the first locking slide and the second locking slide are installed in the frame such that a first force of the first spring urges the first locking slide toward a first position of the first locking slide and a second force of the spring urges the second locking slide toward a first position of the second locking slide.

3. The click-lock assembly of claim 2, wherein the first force acts in a direction opposite to the second force, and wherein the first force and the second force both act in a radially outward direction from the central aperture of the click-lock mechanism to cause the central aperture to be reduced to engage the element within the central aperture.

4. The click-lock assembly of claim 2, wherein to release the click-lock assembly, a first release force urges the first locking slide to a first locking slide second position and a second release force urges the second locking slide to a second locking slide second position.

5. The click-lock assembly of claim 4, wherein the first release force acts in a direction opposite to the second release force, and wherein the first release force and the second release force are in a direction radially inward toward the central aperture so as to extenuate the central aperture to permit the click-lock assembly to be released from the element within the central aperture.

6. The click-lock assembly of claim 1, wherein each distal end of the plurality of locking slides includes an angle in an axial direction relative to the central aperture such that the angle urges the plurality of locking slides from the first position to the second position when the element is inserted into the central aperture from an insertion direction aligned axially with the central aperture, wherein once the element is inserted a given distance into the central aperture, the plurality of locking slides each return to the first position and prevent the element from being removed in a removal direction aligned axially with the central aperture, where the removal direction is opposite to the insertion direction.

7. The click-lock assembly of claim 1, wherein the frame includes a first fixture plate and a second fixture plate, wherein the first fixture plate and the second fixture plate are joined together with one or more fasteners, and wherein the locking slides and springs are secure between the first fixture plate and the second fixture plate.

8. The click-lock assembly of claim 1, wherein the central aperture is formed so as to engage a profile of the element along a first plane, and the locking slides are formed so as to engage an undercut on the element.

9. The click-lock assembly of claim 1, wherein the element includes a mounting rail.

10. The click-lock assembly of claim 1, wherein the element includes one of a slot, a striker, a tang, or a post.

11. The click-lock assembly of claim 1, wherein the central aperture can include one or more surfaces configured to index the element in one or more positions.

12. The click-lock assembly of claim 1, further comprising a plurality of spring loaded safety buttons that are configured to lock the plurality of locking slides into the first position to prevent accidental release, wherein to move the plurality of locking slides form the first position to the second position, a respective spring loaded safety lock must be disengaged to permit the corresponding locking slide to move from the first position to the second position.

13. A click-lock assembly comprising:
a locking slide having a button, a planar member, and a recess at a distal end, wherein the locking slide is configured to move from a first position to a second position when force is applied to the button, wherein the recess of the locking slide forms a central aperture when the locking slide is in the first position, and wherein, in the first position, the locking slide is configured to engage an element within a central aperture, and wherein in the second position, the central aperture is extenuated so as to release the element within the central aperture;
a frame configured to retain the locking slide so as to permit the locking slide to move from the first position to the second position; and
a spring corresponding to the locking slide.

14. The click-lock assembly of claim 13, wherein the locking slide is installed in the frame such that a force of the spring urges the locking slide toward a first position of the locking slide.

15. The click-lock assembly of claim 14, wherein the force of the spring acts in a radially outward direction from the central aperture of the click-lock assembly to cause the central aperture to be reduced to engage the element within the central aperture.

16. The click-lock assembly of claim 14, wherein to release the click-lock assembly, a release force urges the locking slide to the second position.

17. The click-lock assembly of claim 16, wherein the release force is in a direction radially inward toward the central aperture so as to extenuate the central aperture to permit the click-lock assembly to be released from the element within the central aperture.

18. The click-lock assembly of claim 13, wherein the distal end of the locking slide includes an angle in an axial direction relative to the central aperture such that the angle urges the locking slide from the first position to the second position when the element is inserted into the central aperture from an insertion direction aligned axially with the central aperture, wherein once the element is inserted a given distance into the central aperture, the locking slide returns to the first position and prevents the element from being removed in a removal direction aligned axially with the central aperture, where the removal direction is opposite to the insertion direction.

19. The click-lock assembly of claim 13, wherein the central aperture is formed so as to engage a profile of the element along a first plane, and the locking slide is formed so as to engage an undercut on the element.

20. The click-lock assembly of claim 13, wherein the central aperture can include one or more surfaces configured to index the element in one or more positions.
